(19) United States
(12) Patent Application Publication
(10) Pub. No.: US 2024/0352875 A1
(43) Pub. Date: Oct. 24, 2024

(54) Bland/Ewing Cycle improvements

(71) Applicant: Joseph Barrett Bland, Sacramento, CA (US)

(72) Inventor: Joseph Barrett Bland, Sacramento, CA (US)

(21) Appl. No.: 17/746,848

(22) Filed: May 17, 2022

Related U.S. Application Data
(60) Provisional application No. 63/189,634, filed on May 17, 2021.

(51) Int. Cl. F01K 3/18; C09K 5/04

(52) U.S. Cl. CPC F01K 3/188; C09K 5/042; C09K 2205/12

(57) ABSTRACT

The present invention proposes methods and apparatus for improving the technology disclosed in U.S. Pat. No. 3,225,538, U.S. Pat. No. 3,067,594, and U.S. Pat. No. 3,871,179, wherein are detailed techniques for creating a unique thermochemical cycle, termed the Bland/Ewing Cycle (B/E Cycle) after the co-inventors, involving “molecular expansion” and “molecular compression”. The advantage of the B/E Cycle is best exemplified in FIG. 3 and FIG. 4 of U.S. Pat. No. 3,225,538, where P/V and T/S charts indicate the potential for increased “power density”. This power density is a result of the reduced compression work following exothermic conversion of a single mole of gas relative to the increased expansion work following endothermic conversion of multiple moles of gas. The present invention improves power density and/or overall heat engine thermal efficiency by capturing otherwise-waste heat in the exhaust of a B/E Cycle heat engine.

### CROSS-REFERENCE TO RELATED APPLICATIONS

This application claims the benefit of provisional patent application EFS ID 42745216, Application No. 63/189,634, filed 17 May 2021 by the present inventor, which is incorporated by reference in its entirety.

### PRIOR ART

This field is related to a heat engine cycle based on U.S. Pat. No. 3,225,538, U.S. Pat. No. 3,067,594, and U.S. Pat. No. 3,871,179.

### BACKGROUND

The present invention proposes methods and apparatus for improving the technology disclosed in U.S. Pat. No. 3,225,538, U.S. Pat. No. 3,067,594, and U.S. Pat. No. 3,871,179, wherein techniques are detailed for creating a unique thermochemical cycle, termed the Bland/Ewing Cycle (B/E Cycle) after the co-inventors, involving “molecular expansion” and “molecular compression”. The advantage of the B/E Cycle is best exemplified in FIG. 3 and FIG. 4 of U.S. Pat. No. 3,225,538, where P/V and T/S charts indicate the potential for increased “power density”. This power density is a result of the reduced compression work following exothermic conversion of a single mole of gas relative to the increased expansion work following endothermic conversion of multiple moles of gas.

This invention relates to improvements to methods and apparatus employing endothermic chemical reactions and reversible chemical reactions of the endothermic-exothermic type for transfer of heat and/or production of mechanical energy.

The underlying foundational invention takes the form of a heat transfer system in which an endothermic chemical reaction and an exothermic chemical reaction are separately utilized in a cycle for transferring heat from a region of higher temperature to a region of lower temperature. The heat transfer method or system of this foundational invention may be adapted to heat a space or a substance or it may be embodied as a refrigeration system. In another aspect, it may take the form of a method or system for the production of mechanical work. Said method or system may be cyclical, wherein a chemical substance/reactant endothermically reacts to form products, the products are expanded producing work and are then reacted to re-form the initial chemical substance/reactant. Also it is contemplated that a chemical substance/reactant which will undergo an endothermic chemical reaction may be employed to do mechanical work in a method which does not involve converting the reaction products back to the initial chemical substance/reactant.

Stated broadly, this foundational invention utilizes control of changes in enthalpy and concomitant entropy in substances undergoing reversible exothermic-endothermic chemical reactions and conversion of such changes in enthalpy and entropy to sensible energy, as for heating a space or for driving an engine. The energy changes, which are controlled and utilized according to this foundational invention, result at least in part from changes in the chemical composition of the substances involved. Thus, this foundational invention utilizes a different dimension for production and control of sensible energy. This different dimension of control, i.e., change of composition, is one which may be superimposed on the basic controls of temperature, pressure, volume, and changes of phase for deriving sensible energy.

The term “exothermic fluid” as used in this specification and in the claims, means a substance, consisting of one or more elements and/or compounds, in liquid and/or vapor phases, which is formed with liberation of heat (negative heat of reaction) as a result of an exothermic reaction. The term “endothermic fluid” means a substance consisting of one or more elements and/or compounds, in liquid and/or vapor phases, which is formed with absorption of heat (positive heat of reaction) as a result of an endothermic reaction. The exothermic fluid absorbs heat in being converted to an endothermic fluid in an endothermic reaction. The endothermic fluid liberates heat in being converted to an exothermic fluid in an exothermic reaction. The method of this foundational invention comprises passing an amount of a chemical substance which is adapted to under go an endothermic reaction of a reversible chemical reaction into an endothermic reaction chamber; subjecting the contents of the chamber to a constraint which will cause the rate of the endothermic reaction to exceed that of the reverse exothermic reaction of said reversible chemical reaction, with the result that a substantial amount of the exothermic fluid is converted to endothermic fluid, the endothermic fluid thereby acquiring an increase in enthalpy and entropy; and converting at least a substantial part of the energy content of the endothermic fluid to sensible energy, as, for example, for heating a space or for driving an engine. The foundational invention further includes a method in which the endothermic fluid, substantially exhausted of its energy, is passed in a cyclical system to an exothermic-reaction chamber wherein the endothermic fluid is converted back to said exothermic fluid, and subsequent return of the exothermic fluid to said endothermic reaction chamber.

### SUMMARY

In a new embodiment of the foundational B/E Cycle, termed a B/E Liquid Cycle (B/E-L Cycle), compression of a solid or liquid exothermic fluid rather than a gaseous exothermic fluid is proposed, additionally decreasing the work of compression and increasing power density. Note that increased power density permits more of the theoretical potential energy of a heat engine cycle to be captured as work.

In a second improvement of the B/E-L Cycle, a portion of the B/E-L Cycle's exothermic reaction, that is, the engine's waste heat, is used as the heat source for vaporizing the previously pressurized liquid or solid exothermic fluid, thereby increasing overall thermal efficiency.

In a second new embodiment of the B/E Cycle, termed a B/E Combined Cycle (B/E-C Cycle), a high temperature B/E Cycle powers a lower temperature B/E Cycle with the heat of the high temperature B/E Cycle's exothermic reaction, creating a Combined Cycle (CC) heat engine. Note that both new embodiments may be applied separately or in combination to the foundational B/E Cycle.

### BRIEF DESCRIPTION OF THE DRAWINGS

The invention will be illustrated in greater detail by description in connection with specific examples of the practice of it and by reference to the accompanying drawing, in which:

FIG. 1 is based on FIG. 1 in U.S. Pat. No. 3,225,538, which details a cyclical cyclohexane/benzene+hydrogen (C6H12<=>C6H6+3H2) catalytic process, with temperatures in degrees Kelvin and pressure in atmospheres measured logarithmically to the base 10 (an insert graphs the base 10 into the righthand bottom of the figure).

FIG. 2 and FIG. 3 illustrate one approach to constructing a B/E-L Cycle. FIG. 2 is based on a pressure/volume/temperature/BTU/entropy chart from FIG. 70, “Marks Mechanical Engineers 'Handbook”, 1st edition, 9-148, “Internal-combustion engines”, which is incorporated herein by reference.

FIG. 3 is a schematic illustration of a Bland/Ewing Liquid Cycle (B/E-L) engine. A positive displacement piston-and-cylinder configuration is assumed in the specification below. Other approaches such as other positive displacement equipment or multiple turbine blade expanders are clearly also possible.

FIG. 4 and FIG. 5 are similar to FIG. 1 and FIG. 2. However, in FIG. 4 and FIG. 5, a dual thermochemical cycle heat engine is illustrated.

### DETAILED DESCRIPTION

### Description—First Embodiment

One improvement to the foundational invention relates to a method and apparatus for improving the efficiency of a B/E Cycle heat engine. In a B/E-L Cycle, much as in a steam engine, power density can be greatly increased by first pressurizing the exothermic fluid in a liquid or solid state and then converting the fluid into a vapor at constant pressure or volume.

In addition, one beneficial means for supplying the heat energy for vaporizing the exothermic fluid following pressurization is to use the exhaust heat liberated by the exothermic reaction. Since a B/E Cycle's exhaust heat is essentially equal to the heat liberated by the exothermic reaction, it is clear that to the degree the liberated heat can be used to vaporize the heat engine's exothermic fluid the thermal efficiency of the Cycle will be improved.

### Operation—First Embodiment

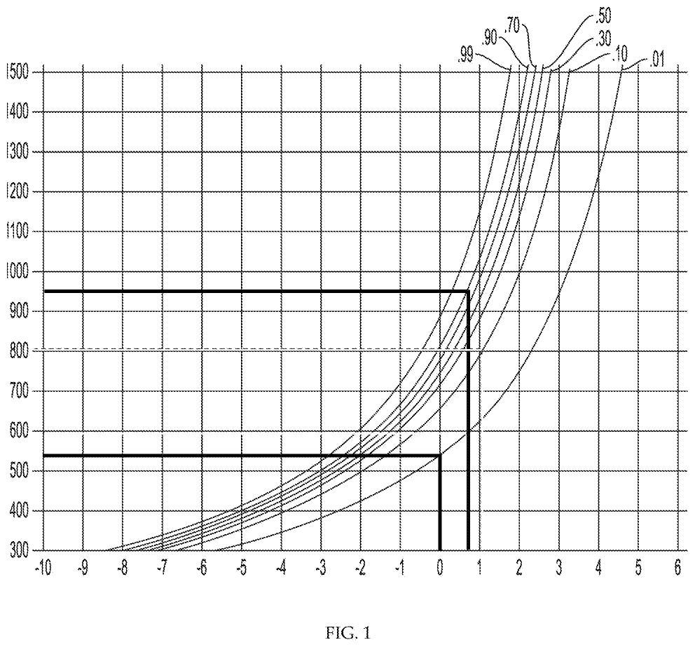

The cyclical and reversible hydrocarbon reaction of 1 mol of cyclohexane (C6H12) generating 1 mol of benzene (C6H6) and 3 mols of hydrogen (H2) will be used to illustrate the proposed inventions. Per FIG. 1, a C6H12<=>C6H6+3H2 catalytic process at a given temperature and pressure will be either endothermic or exothermic. In the proceeding example, FIG. 1 indicates points (shown as the intersection of thin red lines) where, at 5 atmospheres, the temperature for a 90% endothermic conversion equals ˜950 K, while, at 1 atmosphere, the temperature for 99% exothermic conversion equals ˜600 K. These two points will represent the intake and exhaust temperatures and pressures (and endothermic and exothermic reaction temperatures and pressures) for a theoretical B/E-L Cycle heat engine

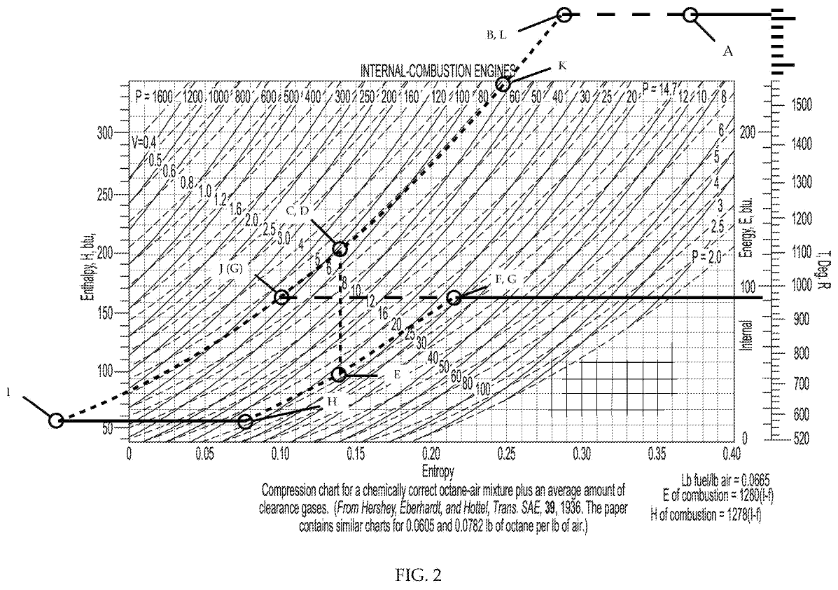

The chart in FIG. 2 is used to indicate a first order estimate of a prototype B/E-L Cycle heat engine. Note that FIG. 2 temperatures are measured in degrees R. The colored lines show the proposed B/E-L Cycle superimposed on the chart, with most of the chart removed for clarity and labeling purposes.

Table 1 below indicates the steps represented by the letters shown in FIG. 2:

### Table 1

A—C6H12 isobaric & isothermal endothermic expansion.

B—C6H6+3H2 isobaric exhaust at 75 psi & ˜1,710° R.

C—Isobaric cooling via heat exchanger #1, dropping C6H6+3H2 to ˜1,180° R.

D—Isobaric expansion completes, isentropic expansion begins.

E—Isentropic expansion ends at ˜750° R.

F—Isobaric reheating of C6H6+3H2 to ˜972° R via heat exchanger #2.

G—C6H6+3H2 isobaric and isothermal exothermic compression (˜972° R).

H—Isobaric cooling/condensation of the C6H12 via heat exchanger #3.

I—Pressurization of liquid C6H12 to 75 psi.

J—Preheating of liquid C6H12 to ˜972° R via heat exchanger #3 & vaporization of liquid C6H12 at 75 psi via heat exchanger #4.

K—Preheating of C6H12 to ˜1,560° R) via heat exchanger #1.

L—Heat source preheating of C6H12 to ˜1,710° R via heat exchanger #5.

Since it was important to keep the cycle elements roughly within the chart's shown boundaries, for this initial analysis, a maximum endothermic temperature is assumed of ˜1,710° R, (950 K, 677° C., 1,250° F.). By lowering the degree of endothermic conversion (in this example to 90%), the required temperature input at a given pressure has been lowered. A maximum pressure of 5 atm (˜75 psi) is assumed. An exothermic pressure of 1 atm or ˜15 psi (shown as 0 in FIG. 1) is likewise assumed. For 99% exothermic conversion, that would equal a temperature of ˜972° R (540° K, 267° C., 512° F.).

Note that, in lowering the degree of endothermic conversion, the cycle's theoretical power density and hence potential real world thermal efficiency is lowered. That is, after the 90% conversion of 1 mol of C6H12, there will be 0.1 mol of C6H12, 0.9 mol of C6H6, and 2.7 mol of H2, resulting in a molecular expansion of 1-to-3.7 rather than 1-to-4.0. Recall that the model is only a general analysis for purposes of illustrating the larger findings herein. Thus, for this analysis, a positive displacement piston-and-cylinder configuration is assumed. Other approaches such as other positive displacement equipment or multiple turbine blade expanders are clearly also possible.

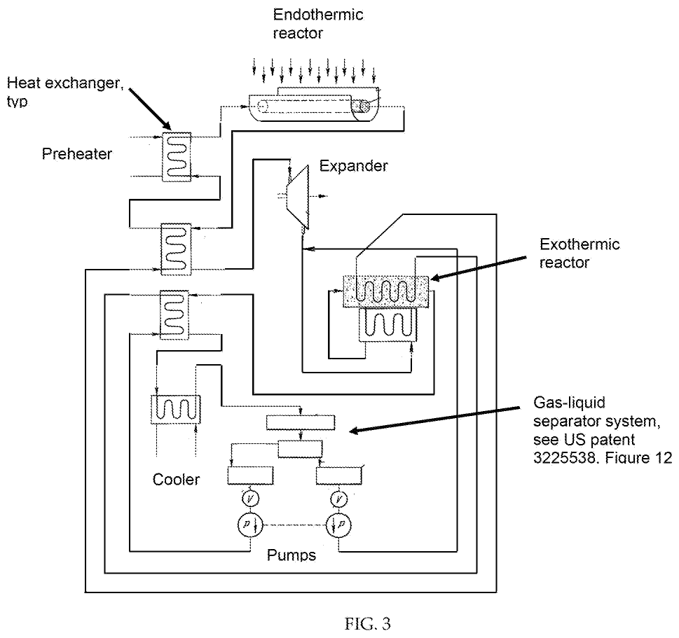

Following the flow process illustrated in FIG. 2, FIG. 3, and Table 1:

A. C6H12 will be converted to C6H6+3H2 in the endothermic reactor at a temperature of ˜1,710° R.

B. The product (C6H6+3H2) will undergo a molecular expansion of about 3.7:1.

C. In counterflow heat exchanger #1, the hot C6H6+3H2 (˜1,710° R) mixture will exchange heat with cool inflowing C6H12 gas (˜972° R), dropping the C6H6+3H2 mixture to ˜1,180° R (process B, C).

D. Work will be generated by a 75 psi, 1,120° R, constant pressure and constant temperature expansion. Prior to TDC, the exhaust valve will have closed. At very near TDC, the expander inlet valve will be opened by pre-compression of remnant gas. Since the clearance space is minimized above the piston, some recompression of the remnant gas will assist the intake valve process by increasing pressure within the expander. Shortly after TDC, the expander inlet valve will be quickly closed, for example by solenoid, having charged the expander cylinder with a quantity of gas at 75 psi.

E. An isentropic expansion will then occur as the piston travels to BDC, dropping the gas to ˜750° R and one atmosphere or ˜15 psi.

F. Following isentropic expansion, the exhaust valve will be opened and the expansion piston will exhaust, at constant pressure and temperature (˜15 psi and ˜750° R), the C6H6+3H2 mixture into radiant heat exchanger #2, located external to to the exothermic reactor, receiving heat from and partially cooling the reactor, and raising the C6H6+3H2 mixture to ˜972° R. Simultaneously, a previous charge of the C6H6+3H2 mixture at ˜15 psi will exhaust through the exothermic reactor, converting the gases to C6H12 at a constant pressure and undergoing a molecular compression of about 1:4.

G. Simultaneously, the previous charge of ˜15 psi C6H12 vapor at ˜972° R will exhaust into counterflow heat exchanger #3, which will ideally cool it to less than 600° R. If necessary, a charge of the cooled C6H12 vapor will simultaneously exhaust into a simple cooler to achieve final condensation into liquid C6H12 (point H). Any H2 gas entrained in the stream leaving counterflow heat exchanger #3 or the cooler will be separated from the liquid and directed back to the exhaust stream leaving the expander.

H. The liquid C6H12 will then be pumped up to a pressure of ˜75 psi.

I. The ˜75 psi liquid C6H12 will then be warmed by the ˜15 psi C6H12 flowing into counterflow heat exchanger #3. The ˜75 psi C6H12 liquid/vapor mix will then be used to further cool the exothermic reactor in radiant heat exchanger #4, simultaneously converted any remaining liquid into vapor at a temperature of ˜972° R.

J. The ˜75 psi C6H12 vapor will then be partially raised in temperature (˜1,560° R) by counterflow heat exchanger #1 from the C6H6+3H2 exiting the endothermic reactor.

K. The ˜75 psi C6H12 vapor will then use heat source radiant heat exchanger #5 to reach the required maximum temperature (˜1,710° R) just prior to being fed to the endothermic reactor.

L. And thus back to the initial state.

Looking at the C6H12 <=>C6H6+H2 reaction, benzene is chemically highly active. Therefore, parts of the engine that will come in contact with benzene such as the pistons, connecting rod, cylinder head, cylinder base, valves, connecting manifolds, seals, etcetera, will need to either be fabricated or plated from non-reactive materials such as stainless steel, teflon, or nickel.

The B/E Cycle creates unique challenges in the area of engine seals. Stainless seals are possible, but seal lubrication becomes an issue. Lubrication is generally important as a means of reducing friction losses and increasing engine durability, but lubricants in the working fluid could seriously impact the quality of a thermochemical cycle. Ideally, a non-reactive material that doesn't require lubrication such as teflon would be used where required. However, in the example of the C6H12<=>C6H6+3H2 cycle engine operating with a peak temperature of ˜1,710° (FIG. 2), that temperature is far in excess of the temperature teflon can support. Teflon seals will work up to about 1,000° R, but no commonly known low friction, non-lubricated, chemically inert seal can handle a constant temperature of 1,710° R.

One partial solution to the reducing seal temperature is to create a positive displacement “blended” expansion cycle. That is, work is done initially at constant pressure with the entry of the working fluid into the positive displacement expander via an inlet valve. After some expansion, the inlet valve is closed and an isentropic expansion process continues, thus dropping the average temperature of the working fluid that seals need to be subjected to per cycle. However, with an inlet temperature of 1,710°, it will be difficult to achieve a temperature sufficient to protect the teflon piston seals with a simple isentropic expansion.

For the prototype, an additional solution is to exchange heat between the cooler C6H12 constant pressure reactant stream entering the endothermic reactor and the hotter constant pressure C6H6+3H2 product stream exiting the reactor. Of course, such a thermal exchange will significantly lower the potential thermal efficiency of the engine by reducing the peak temperature seen by the expansion process. For advanced versions, alternative high temperature pre-expanders such as turbo-expanders are an obvious solution to regain thermal efficiency.

One well known technique for exchanging heat between two gas/vapor streams is the use of a counterflow heat exchanger. The gas exhausting from the endothermic reactor flows through a manifold in immediate physical proximity to a manifold with gas entering the endothermic reactor, said manifolds thus exchanging heat and simultaneously heating the inflowing reactants while cooling the outflowing products. Note that this is normally done at constant pressure in the gas/vapor streams, and that the two gas/vapor streams don't necessarily need to operate at the same pressure.

### Description—Second Embodiment

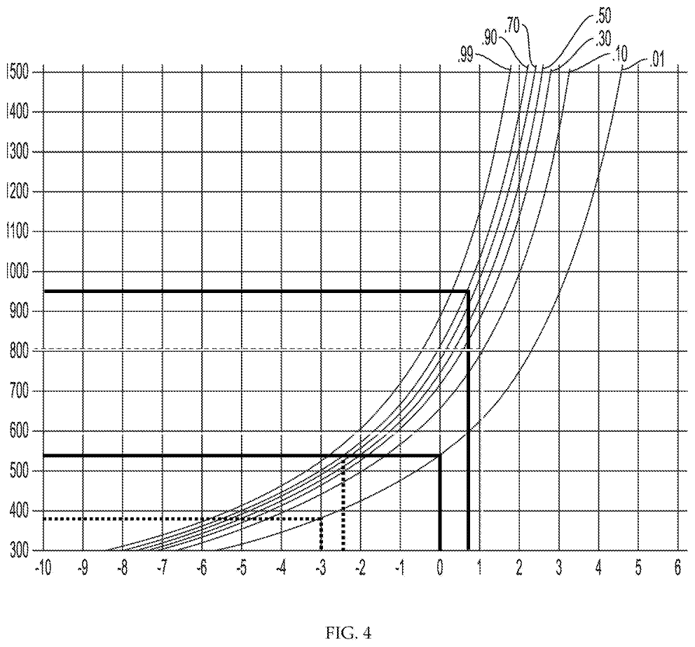

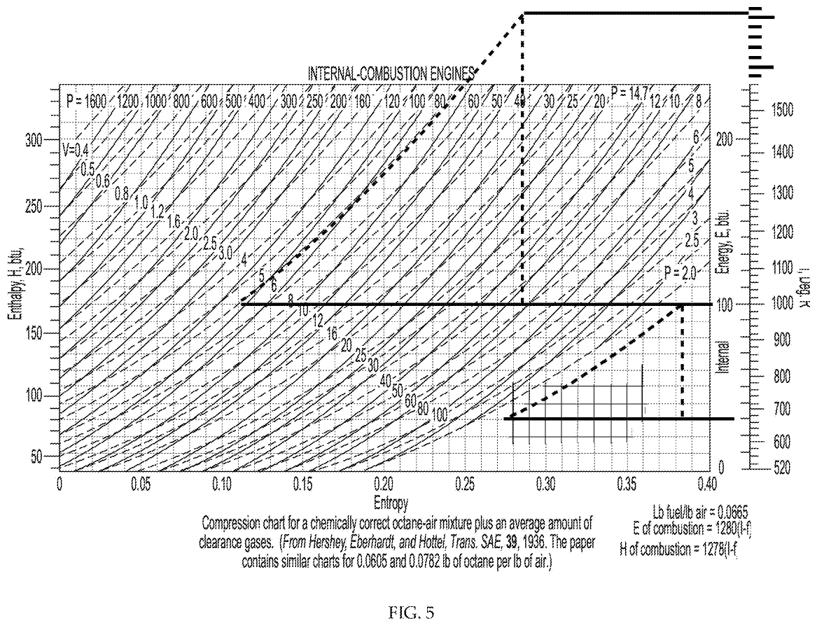

In FIGS. 4 and 5, a cycle substantially below atmospheric pressure is shown. The red lines in FIG. 4 show the variance in pressures and temperatures for endothermic and exothermic reactions for the the high temperature B/E-CC engine, and the green lines in FIG. 4 show the variance in pressures and temperatures for endothermic and exothermic reactions for the low temperature B/E-CC engine. For the high temperature B/E-CC, endothermic temperature at about 90% conversion equals about 950 K, while exothermic temperature at 99% conversion equals about 550 K. For the low temperature B/E-CC engine, at a temperature of about 550 K, a 90% endothermic reaction will occur at a pressure of about 0.0075 atmospheres (0.11 psi). At a pressure of 0.001 atmosphere (0.015 psi) and a temperature of about 375° K, a 99% exothermic reaction will occur. The expansion ratio of the low temperature engine would equal (0.11/0.015=) ˜7.3 to 1.

### Operation—Second Embodiment

The reason there may be a chance for such a cycle to actually be functional is due to the thermochemical expansion process of the B/E heat engine concept, which greatly increases power density for a given pressure regime. One place where there may be a meaningful application for such a cycle is in space, where a near-perfect vacuum exists.

As a result, there is no need to deal with external atmospheric pressure in the mechanical design. Thus, walls of chambers can be exceedingly thin and low mass, as can positive displacement elements such as pistons. And at the low temperatures, teflon seals would be adequate throughout, aiding in reducing friction. Volumes of positive displacement equipment can thus be very large, compared to terrestrial systems, yet very low in mass.

The possibility of an exceedingly low pressure engine also raises the possibility that a low temperature B/E-CC Cycle can actually produce useful work. One intriguing potential application is to use a B/E-CC cyclohexane thermochemical cycle on the lunar surface. Note that the final exhaust temperature of 375 K is sufficient to boil water at 1 atmosphere pressure or less. Hence, if lunar regolith which contains entrained water molecules can be brought to that temperature and pressure, the lunar regolith should release most of the entrained water molecules. Importantly, an exothermic catalytic chamber or chambers can be created inside an object requiring low temperature heating, such as a tool for mining lunar soil containing ice, such as can be found in the super-cold environment of a PSR found in the vicinity of the lunar poles, allowing excess exothermic heat to be used to good effect. This is a direct and very efficient alternative to electrical heating of such tools.

### Conclusion, Ramifications, and Scope

Other thermochemical cycles are possible, as disclosed in U.S. Pat. No. 3,225,538, U.S. Pat. No. 3,067,594, and U.S. Pat. No. 3,871,179, and therefore the C6H12<=>C6H6+3H2 cycle is used as a general example. Also, pressure and temperature define endothermic and exothermic processes of heat absorption and rejection. Accordingly, all calculations herein should be considered only useful as means of generally illustrating the larger findings herein.

What is claimed is:

1. A method similar to the transfer of heat comprising the steps of claim 1 in U.S. Pat. No. 3,225,538 and adding the steps of (1) vaporizing a pre-pressurized quantity of liquid or solid paraffin/alkane reactant at the preferred pressure regime of the endothermic reactor, (2) converting said vaporized and preheated paraffin reactant within the endothermic reactor to olefin/alkene and hydrogen product at constant pressure and temperature, (3) adjusting said olefin and hydrogen product pressure and temperature to the preferred pressure and temperature regime of the exothermic reactor, (4) converting said olefin and hydrogen product back to the original paraffin at constant temperature and pressure, (5) cooling the resulting paraffin back to a liquid or solid state, and (6) compressing said resulting paraffin to the preferred pressure regime of the endothermic reactor.

2. The method of claim 1, where a portion of the heat evolved by an earlier cycle of olefin and hydrogen product passing through an exothermic reactor is used to vaporize the pre-pressurized liquid or solid paraffin.

3. A method similar to the transfer of heat comprising the steps of claim 1 in U.S. Pat. No. 3,225,538 and adding the step of using a portion of the heat evolved by a cycle of olefin and hydrogen product passing through a high pressure exothermic reactor to add source heat to a second much lower temperature and pressure thermochemical cycle comprising the steps of claim 1 in U.S. Pat. No. 3,225,538.
